(19) United States
(12) Patent Application Publication
(10) Pub. No.: US 2017/0204946 A1
(43) Pub. Date: Jul. 20, 2017

(54) ONE-WAY CLUTCH AND VARIABLE TRANSMISSION COMPRISING SAME

(71) Applicant: Young Gu BAEK, Gyeongsangbuk-do (KR)

(72) Inventor: Young Gu BAEK, Gyeongsangbuk-do (KR)

(21) Appl. No.: 15/129,693

(22) PCT Filed: Mar. 27, 2015
(86) PCT No.: PCT/KR2015/003051

§ 371 Date: Apr. 3, 2017

(30) Foreign Application Priority Data
Mar. 27, 2014 (KR) 10-2014-0036264
Apr. 4, 2014 (KR) 10-2014-0040648

(51) Int. Cl. F16H 9/10; F16D 27/01; F16H 9/24; F16D 41/063

(52) U.S. Cl. CPC F16H 9/10; F16D 41/063; F16D 27/01; F16H 9/24

(57) ABSTRACT

Disclosed are a one way clutch and a continuously variable transmission including the same capable of improving reliability and stability. The one way clutch includes: an outer race; an inner race disposed in the outer race to be coaxially rotatable; and a wedge type clutch element provided between the outer race and the inner race, and an element accommodation section is provided at least at any one side of an interface of the outer race and the inner race and the clutch element is accommodated in the element accommodation section.

### TECHNICAL FIELD

The present invention relates to a one way clutch, and more particularly, to an one way clutch using a wedge and a continuously variable transmission including the same.

### BACKGROUND ART

One way clutch which is used for transfer power only in one direction is widely used in power transmission devices including a transmission, and the like and various tools such as a screwdriver.

In general, one way clutch primarily used in the power transmission device includes a sprag type using a sprag, a roller type using a roller supported by a spring, and the like.

In the case of the sprag type one way clutch, when an outer rotator rotates clockwise, the sprag installed between an inner rotator and the outer rotator is inclined to a right side, and as a result, the outer rotator can arbitrarily rotate and when the outer rotator rotates counterclockwise, the sprag is inclined to a left side, and as a result, the outer rotator cannot rotate to perform a one-way clutch function.

However, in the case of the existing sprag type one way clutch, the position of the sprag is settled and guided by mounting a cage mounted in a space between the inner and outer rotators in order to fix the sprag and a separate ribbon spring needs to be mounted between the cases in order to closely attach the sprag in a rotational direction, and as a result, a structure is complicated and there is a structural limit in controlling the size of the sprag.

In the case of the roller type one way clutch, when the outer rotator rotates clockwise, the roller supported by the spring is separated from the inner rotator while moving to the spring, and as a result, the outer rotator can arbitrarily rotate and when the outer rotator rotates counterclockwise, the roller contact the inner rotator while moving in an opposite side to the spring, and as a result, the outer rotator cannot rotate to perform the one-way clutch function.

However, only when an additional component such as the spring needs to be further provided, the existing roller type one way clutch may also perform the one way clutch function, a configuration is complicated and cost is lost and in particular, precise processing is required.

Further, in the case of the existing one way clutch, as lock and unlock is configured to be made by the sprag or the roller disposed between the outer rotator and the inner rotator, stability and accuracy deteriorate. In particular, in the related art, when the rock and the unlock are switched to each other, slip and backlash occur and it is difficult to transfer sufficient torque and it is difficult to rapidly implement switching of the lock and the unlock.

Further, in the case of the existing one way clutch, when a ball or the roller is abraded or stabbed by a repeated clutch operation, it is difficult that the ball or roller plays a proper role thereof.

As a result, in recent years various researches into a one way clutch in which the lock and the unlock can be accurately switched to each other have been made, but the one way clutch has not yet been insufficient. Therefore, the development of the corresponding one way clutch has been acutely required.

### DISCLOSURE

### Technical Problem

The present invention has been made in an effort to provide a one way clutch capable of improving reliability and stability.

In particular, the present invention has been made in an effort to provide a one way clutch using a one way clutch which can reduce slip and backlash phenomena and be rapidly switched to lock and unlock and a continuously variable transmission including the same.

Further, the present invention has been made in an effort to provide a one way clutch capable of simplifying a structure and a manufacturing process and a continuously variable transmission including the same.

In addition, the present invention has been made in an effort to provide a continuously variable transmission capable of rapidly and accurately performing a shift control.

### Technical Solution

In one aspect, the present invention provides a one way clutch including: an outer race; an inner race disposed in the outer race to be coaxially rotatable; and a wedge type clutch element provided between the outer race and the inner race, and an element accommodation section is provided at least at any one side of an interface of the outer race and the inner race and the clutch element is accommodated in the element accommodation section.

For reference, the one way clutch according to the present invention may be used in power transmission device of a vehicle, a bicycle, a ship, an airplane, ad the like or a tool such as screwdriver and the present invention is restricted or limited by a type and a characteristic of an application object to which the one way clutch is applied.

A wedge type clutch element may be provided in various structures according to a condition and a design specification which are required. As one example, the clutch element may include a plane contact portion surface-contacting the element accommodation section and a curved clamping portion facing the plane contact portion.

The element accommodation section may be provided in a structure in which the clutch element is plane-contactable. As one example, the element accommodation section may include a plane floor portion formed to be inclined to a tangential direction of an outer peripheral surface of the inner race so that one end of both ends of the inner race is relatively closer to the center of the inner race, a first wall portion formed from one end of the plane floor portion relatively closer to the center of the inner race between both ends of the plane floor portion up to the outer peripheral surface of the inner race, and a second wall portion formed from the other end of the plane floor portion up to the outer peripheral surface of the inner race, and the clutch element may be disposed between the first wall portion and the second wall portion and the curved clamping portion may be provided to surface-contact an inner peripheral surface of the outer race in a rotational direction of the outer race to the inner race to be selectively locked or unlocked on the inner peripheral surface of the outer race.

Herein, a state in which the clutch element is locked on the inner peripheral surface of the outer race may be appreciated as a state in which rotation of the outer race to the inner race is restricted and relative rotation of the outer race to the inner race may be restricted while rotation of the clutch element to the outer race is restricted. Further, a state in which the clutch element is unlocked on the inner peripheral surface of the outer race may be appreciated as a state in which the rotation of the clutch element to the outer race is permitted and the relative rotation of the outer race to the inner race may be restricted while the rotation of the clutch element to the outer race is permitted.

The number of element accommodation sections and the number of clutch elements corresponding thereto may be appropriately changed according to a condition and a design specification which are required. Preferably, even element accommodation sections and clutch elements may be provided at an even interval in a circumferential direction of the inner race to be symmetric to each other base on the center of the inner race. In some cases, odd or even element accommodation sections and clutch elements may be provided to be asymmetric to each other based on the center of the inner race, but when the element accommodation section and the clutch element are provided to be asymmetric to each other, backlash and slip phenomena occur at the time of switching the lock and the unlock, and as a result, even element accommodation sections and clutch elements are preferably provided in the circumferential direction of the inner race to be symmetric to each other based on the center of the inner race.

Design conditions of the element accommodation section and the clutch element may be appropriately changed according to the condition and the design specification which are required.

Preferably, so as to rapidly switch the lock and the unlock, while the clutch element is unlocked on the inner peripheral surface of the outer race, the gap ΔH of 0.001 to 0.05 mm may be provided between the curved clamping portion 534 and the inner peripheral surface of the outer race. For reference, since when the gap ΔH between the curved clamping portion and the inner peripheral surface of the outer race is smaller than 0.001 mm in the unlocked state, it is difficult to rapidly switch the lock and the unlock and when the gap ΔH between the curved clamping portion and the inner peripheral surface of the outer race is smaller than 0.05 mm in the unlocked state, the backlash phenomenon occurs at the time of rapidly switching the lock and the unlock, it is preferable that the gap ΔH of 0.001 to 0.05 mm is provided between the curved clamping portion and the inner peripheral surface of the outer race while the clutch element is unlocked on the inner peripheral surface of the outer race. More preferably, the gap ΔH of 0.02 mm may be provided between the curved clamping portion and the inner peripheral surface of the outer race in the unlocked state.

Further, an angle θ1 of the plane contact portion for a chord of the curved clamping portion is in the range of 5° to 20°. That is, when the angle θ1 of the plane contact portion for the chord of the curved clamping portion is smaller than 5°, comparatively large rotational force needs to be required at the time of switching the lock and the unlock and when the angle θ1 of the plane contact portion for the chord of the curved clamping portion is smaller than 20°, it is difficult to guarantee the sufficient clamping force and it is difficult to stably maintain the lock and unlock states, and as a result, the angle θ1 of the plane contact portion for the chord of the plane clamping portion is preferably configured in the range of 5° to 20°. More preferably, a movement distance ΔL of the clutch element to the plane floor portion may be configured in the range of 0.003 mm to 0.572 mm at the time of switching the lock and the unlock with each other.

Further, an allowance tolerance L2 may be provided between the second wall portion and the clutch element in the locked state of the clutch element. The allowance tolerance L2 may be appropriately changed according to the condition and design specification which are required. Preferably, the allowance tolerance L2 may be provided in the range of 0.2 mm to 1 mm.

Further, a round processing unit may be formed at a corner of the clutch element exposed to the outside of the element accommodation section and the round processing unit may prevent a phenomenon in which the corner of the clutch element is stabbed on the inner peripheral surface of the outer race at the time of switching the lock and the unlock of the clutch element.

According to another exemplary embodiment of the present invention, the one way clutch may further include a return means providing return force when the clutch element in the locked state is returned in the unlocked state. As one example, the return means may include a first magnet coating layer formed on the surface of the first wall portion and a second magnet coating layer formed on the surface of the clutch element facing the first wall portion to have repulsive force with the first magnet coating layer.

In another aspect, the present invention provides a continuously variable transmission including a first disk unit with a first guide slot, a second disk unit with a second guide slot which the first guide slot crosses, and a guide member provided to move along the first guide slot and the second guide slot in response to relative rotation of the second disk unit to the first disk unit, including a one way clutch integrally provided in the guide member, and the one way clutch includes an inner race and an outer race defining at least one element accommodation section on an interface, and a wedge type clutch element is provided in the element accommodation section.

The first disk unit 2 may be constituted by a single disk member or a plurality of disk members according to a condition a design specification which are required. The first disk unit and the second disk unit may be constituted by disk members of the same number as each other and in some cases, the first disk unit and the second disk unit may be constituted by disk members of different number from each other.

For reference, defining at least one element accommodation section on an interface of the inner race and the outer race may be appreciated as providing the element accommodation section at least at any one side of an outer peripheral surface of the inner race and an inner peripheral surface of the outer race.

### Advantageous Effects

According to a one way clutch and a continuously variable transmission including the same, reliability and stability can be improved.

According to the present invention, a wedge type clutch element including a plane contact portion and a curved clamping portion is used to improve clamping force and enable rapidly switching of lock and unlock. Accordingly, the continuously variable transmission including the one way clutch according to the present invention enables a rapid and accurate shift control and can reduce a shift shock.

In particular, according to the present invention, since while the clutch element is unlocked onto the inner peripheral surface of an outer race, a gap ΔH of can be provided between the curved clamping portion and the inner peripheral surface of the outer race, an angle θ1 of the plane contact portion to a chord of the curved clamping portion may be provided as 5° to 20°, and a movement distance ΔL of the clutch element for a plane floor portion during switching between the lock and the unlock can be provided as 0.003 mm to 0.572 mm, slip and backlash phenomena can be minimized during switching between the lock and the unlock and a switching time can be further shortened.

Further, in the case of the existing one way clutch, when a ball or the roller is abraded or stabbed by a repeated clutch operation, it is difficult that the ball or roller plays a proper role thereof, but in the present invention, since the curved clamping portion of the clutch element can perform a clutch operation through surface contacting, the clutch element can play the proper role thereof even though the clutch element is abraded by the repeated clutch operation.

Moreover, according to the present invention, since an allowance tolerance can be provided between a second wall portion and the clutch element in a lock state of the clutch element, a lock operation between the curved clamping portion and the outer race can be normally performed by an allowance tolerance section even though the curved clamping portion and the inner peripheral surface of the outer race are abraded with a predetermined degree by the repeated clutch operation.

Further, according to the present invention, since the wedge type one way clutch is used and shifting can be achieved by combining only one first disk unit and only one second disk unit, the shifting is enabled even in a non-rotation state of the first disk unit and the second disk unit. That is, in the existing method in which the shifting is achieved by combining two first disk units and two second disk units, the shifting needs to be particularly achieved in a rotation state so as to prevent a power transfer member from being drooped and sagged during the shifting. However, in the present invention, since the shifting can be achieved by combining only one first disk unit and only one second disk unit by using the wedge type one way clutch, the shifting is enabled even in the non-rotation state of the combination of the first disk unit and the second disk unit.

Further, according to the present invention, output power can be further improved and continuity and stability of power transmission can be maintained.

### DESCRIPTION OF DRAWINGS

FIGS. 1 and 2 are diagrams illustrating a one way clutch according to the present invention.

FIG. 3 is a cross-sectional view taken along line I-I of FIG. 1.

FIGS. 4 and 5 are diagrams for describing an operation structure of a one way clutch according to the present invention.

FIGS. 6 and 8 are diagrams for describing a continuously variable transmission adopting the one way clutch according to the present invention.

FIG. 9 is a diagram for describing a dart game apparatus according to another exemplary embodiment of the present invention.

### BEST MODE

Hereinafter, exemplary embodiments of the present invention will be described in detail with reference to the accompanying drawings, but the present invention is not limited or restricted to the exemplary embodiments. For reference, in the description, like reference numerals substantially refer to like elements, which may be described by citing contents disclosed in other drawings under such a rule and contents determined to be apparent to those skilled in the art or repeated may be omitted.

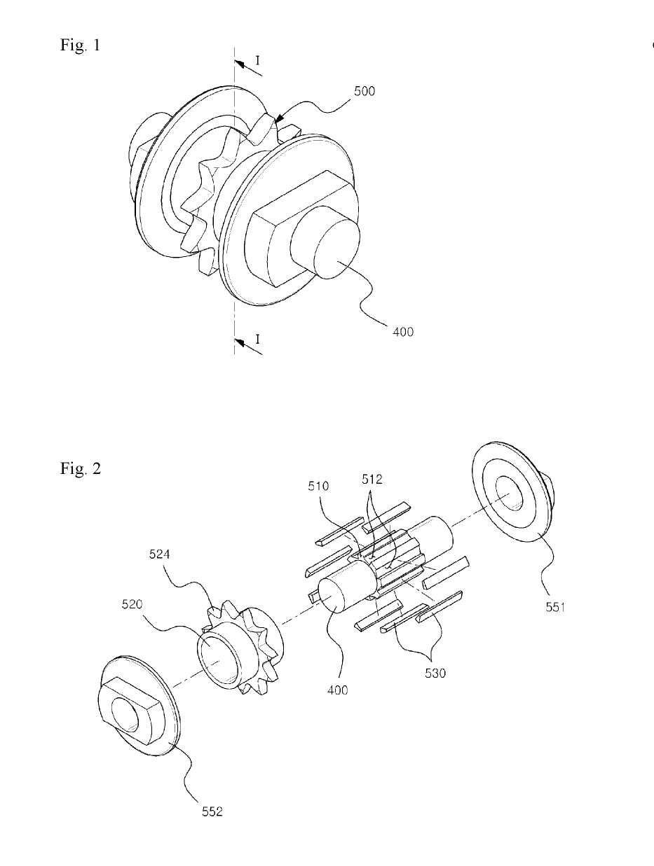

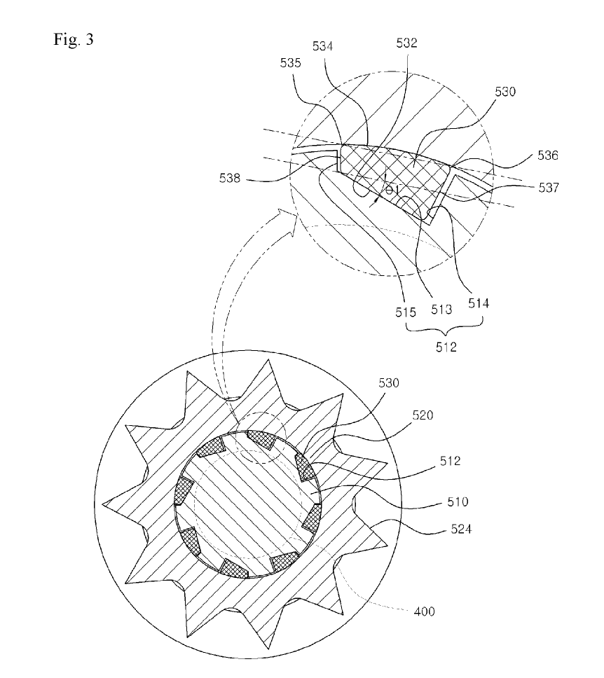

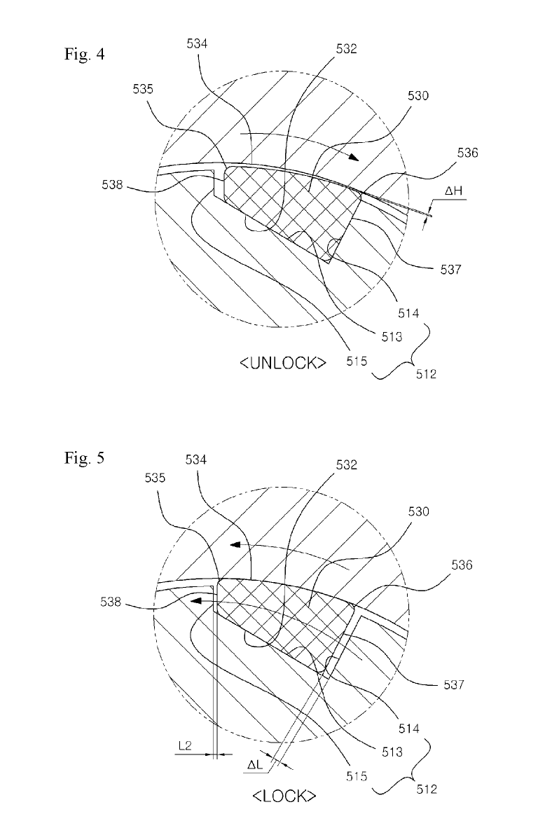

FIGS. 1 and 2 are diagrams illustrating a one way clutch according to the present invention, FIG. 3 is a cross-sectional view taken along line I-I of FIG. 1, and FIGS. 4 and 5 are diagrams for describing an operation structure of a one way clutch according to the present invention.

Referring to FIGS. 1 to 3, the one way clutch according to the present invention is configured to include an inner race 510, an outer race 520, and a clutch element and configured in such a manner that only unidirectional rotation of the outer race to the inner race is permitted.

The inner race 510 may be integrally provided on a driven shaft or an output shaft and an element accommodation section 512 for accommodating a clutch element 530 to be described below is formed on an outer peripheral surface of the inner race 510.

For reference, in the present invention, integrally providing the inner race 510 to the driven shaft or the output shaft may be appreciated as a state in which the inner race 510 is integrally rotatably coupled to or formed on the driven shaft or the output shaft.

The outer race 520 is coaxially disposed on an exterior of the inner race 510 to be relatively rotatable to the inner race 510.

For reference, in the exemplary embodiment of the present invention, it is described that the element accommodation section 512 is formed on the outer peripheral surface of the inner race 510 as an example, but in some cases, the element accommodation section may be formed on the inner peripheral surface of the outer race to be described below.

The clutch element 530 may be accommodated in the element accommodation section 512 of the inner race 510 and selectively locked or unlocked on the inner peripheral surface of the outer race 520 according to a rotational direction of the outer race 520 to the inner race 510.

Herein, a state in which the clutch element 530 is locked on the inner peripheral surface of the outer race 520 may be appreciated as a state in which rotation of the clutch element 530 to the outer race 520 is restricted and in the state in which the rotation of the clutch element 530 to the outer race 520 is restricted, relative rotation of the outer race 520 to the inner race 510 may be restricted.

Further, a state in which the clutch element 530 is unlocked on the inner peripheral surface of the outer race 520 may be appreciated as a state in which the rotation of the clutch element 530 to the outer race 520 is permitted and in the state in which the rotation of the clutch element 530 to the outer race 520 is permitted, the relative rotation of the outer race 520 to the inner race 510 may be permitted.

The element accommodation section 512 is provided to have a size to partially accommodate the clutch element 530 and while the clutch element 530 is partially accommodated by the element accommodation section 512, the clutch element 530 may be selectively locked or unlocked on the inner peripheral surface of the outer race 520 according to the rotational direction of the outer race 520 to the inner race 510.

In more detail, the element accommodation section 512 includes a plane floor portion 513 formed to be inclined to a tangential direction of the outer peripheral surface of the inner race 510 so that one end of both ends is relatively closer to the center of the inner race 510, a first wall portion 514 formed from one end of the plane floor portion 513 relatively closer to the center of the inner race 510 between both ends of the plane floor portion 513 up to the outer peripheral surface of the inner race 510, and a second wall portion 515 formed from the other end of the plane floor portion 513 up to the outer peripheral surface of the inner race 510 and is formed in a substantially “ [symbol] ”-shape groove form.

The clutch element 530 includes a plane contact portion 532 surface-contacting the plane floor portion 513 and a curved clamping portion 534 which may surface-contact the inner peripheral surface of the outer race 520 and is formed in a substantially wedge form and is accommodated in the element accommodation section 512 to be disposed between the first wall portion 514 and the second wall portion 515. Moreover, hereinafter, an end of the clutch element 530 facing the first wall portion 514 will be referred to as a first end 537 and the other end of the clutch element 530 facing the second wall portion 515 will be referred to as a second end 538.

The plane contact portion 532 of the clutch element 530 may move on the element accommodation section 512 while surface-contacting the plane floor portion 513 according to the rotational direction of the outer race 520 to the inner race 510 and the curved clamping portion 534 may selectively contact the inner peripheral surface of the outer race 520 according to the rotational direction of the outer face 520 to the inner race 510. For reference, the state in which the curved clamping portion 534 contacts the inner peripheral surface of the outer race 520 may be appreciated as the state in which the clutch element 530 is locked on the inner peripheral surface of the outer race 520, and as a result, the relative rotation of the outer race 520 to the inner race 510 may be restricted by clamping force (friction force) depending on the contacting of the clutch element 530 to the inner peripheral surface of the outer race 520 and the inner race 510 may rotate in one same direction together to correspond to the unidirectional rotation of the outer race 520.

For reference, in the exemplary embodiment which is described above and illustrated, an example in which the element accommodation section is configured to include the plane floor portion is described, but in some cases, a curved floor portion is formed instead of the plane floor portion and a curved contact portion which may surface-contact the curved floor portion may be formed instead of the plane contact portion of the clutch element.

The number of element accommodation sections 512 and the number of clutch elements 530 corresponding thereto may be appropriately changed according to a condition and a design specification which are required. Preferably, even (for example, 6, 8, 10, 12, and the like) element accommodation sections 512 and clutch elements 530 may be provided at an even interval in a circumferential direction of the inner race 510 so as to be symmetric to each other based on the center of the inner race 510. In some cases, odd (for example, 5, 7, 9, and the like) element accommodation sections 512 and clutch elements 530 may be provided to be asymmetric to each other based on the center of the inner race, but when odd element accommodation sections and clutch elements are provided, the backlash and slip phenomena occur during switching of the lock and the unlock and when even element accommodation sections and clutch elements are provided to be asymmetric to each other based on the center of the inner race, the backlash and slip phenomena occur during switching of the lock and the unlock, and as a result, even element accommodation sections and clutch elements are preferably provided in the circumference direction of the inner race to be symmetric to each other based on the center of the inner race.

As described above, in the present invention, the clutch element 530 is formed in a wedge form including the plane contact portion 532 and the curved clamping portion 534 to provide sufficient clamping force, reduce the slip and backlash phenomena, and enable the rapid switching of the lock and the unlock.

Design conditions of the element accommodation section 512 and the clutch element 530 may be appropriately changed according to the condition and the design specification which are required.

Preferably, referring to FIGS. 3 to 5, so as to rapidly switch the lock and the unlock, while the clutch element 530 is unlocked on the inner peripheral surface of the outer race 520, the gap ΔH of 0.001 to 0.05 mm may be provided between the curved clamping portion 534 and the inner peripheral surface of the outer race 520. For reference, since when the gap ΔH between the curved clamping portion 534 and the inner peripheral surface of the outer race 520 is smaller than 0.001 mm in the unlocked state, it is difficult to rapidly switch the lock and the unlock and when the gap ΔH between the curved clamping portion 534 and the inner peripheral surface of the outer race 520 is smaller than 0.05 mm in the unlocked state, the backlash phenomenon occurs at the time of rapidly switching the lock and the unlock, it is preferable that the gap ΔH of 0.001 to 0.05 mm is provided between the curved clamping portion 534 and the inner peripheral surface of the outer race 520 while the clutch element 530 is unlocked on the inner peripheral surface of the outer race 520. More preferably, the gap ΔH of 0.02 mm may be provided between the curved clamping portion 534 and the inner peripheral surface of the outer race 520 in the unlocked state.

An angle θ1 of the plane contact portion 532 for a chord of the curved clamping portion 534 may be configured in the range of 5° to 20°. That is, when the angle θ1 of the plane contact portion 532 for the chord of the curved clamping portion 534 is smaller than 5°, comparatively large rotational force needs to be required at the time of switching the lock and the unlock and when the angle θ1 of the plane contact portion 532 for the chord of the curved clamping portion 534 is smaller than 20°, it is difficult to guarantee the sufficient clamping force and it is difficult to stably maintain the lock and unlock states, and as a result, the angle θ1 of the plane contact portion 532 for the chord of the plane clamping portion 534 is preferably configured in the range of 5° to 20°.

More preferably, under such a condition, a movement distance ΔL of the clutch element 530 to the plane floor portion 513 may be configured in the range of 0.003 mm to 0.572 mm at the time of switching the lock and the unlock of the clutch element 530. Herein, the movement distance ΔL of the clutch element 530 to the plane floor portion 513 may be appreciated as a straight movement distance of the plane contact portion 532 which moves in the surface contact state on the plane floor portion 513 at the time of switching the lock and the unlock.

Further, referring to FIG. 5, an allowance tolerance L2 may be provided between the second wall portion 515 and the clutch element 530 in the lock state of the clutch element 530. In such a structure, even though the curved clamping portion 534 and the inner peripheral surface of the outer race 520 are abraded by the repeated clutch operation, a lock operation between the curved clamping portion 534 and the outer race 520 may be normally performed by the allowance tolerance section. The allowance tolerance L2 may be appropriately changed according to the condition and design specification which are required. Preferably, when the allowance tolerance L2 may be configured as a value larger than 0.2 mm and more preferably, the allowance tolerance L2 may be provided in the range of 0.2 mm to 1 mm.

When the clutch element 530 is abreacted with a predetermined degree or more by the repeated clutch operation (lock and unlock switching), the second end 538 of the clutch element 530 is restricted by the second wall portion 515 to prevent a lock inability state depending on the abrasion.

Further, round processing units 535 and 536 may be formed at corners of the clutch element 530 exposed to the outside of the element accommodation section 512. In more detail, the round processing units 535 and 536 having predetermined radii may be formed at the corner of the first end 537 and the corner of the second end 538 adjacent to the inner peripheral surface of the outer race 520. The round processing units 535 and 536 may prevent a phenomenon in which the corner of the clutch element 530 is stabbed on the inner peripheral surface of the outer race 520 at the time of switching the lock and the unlock of the clutch element 530. In some cases, the round processing unit may be formed at only any one side of the corner of the first end and the corner of the second end.

For reference, the one way clutch according to the present invention may be used in power transmission device of a vehicle, a bicycle, a ship, an airplane, ad the like or a tool such as screwdriver and the present invention is restricted or limited by a type and a characteristic of an application object to which the one way clutch is applied. Hereinafter, an example in which the one way clutch according to the present invention is applied to the continuously variable transmission will be described.

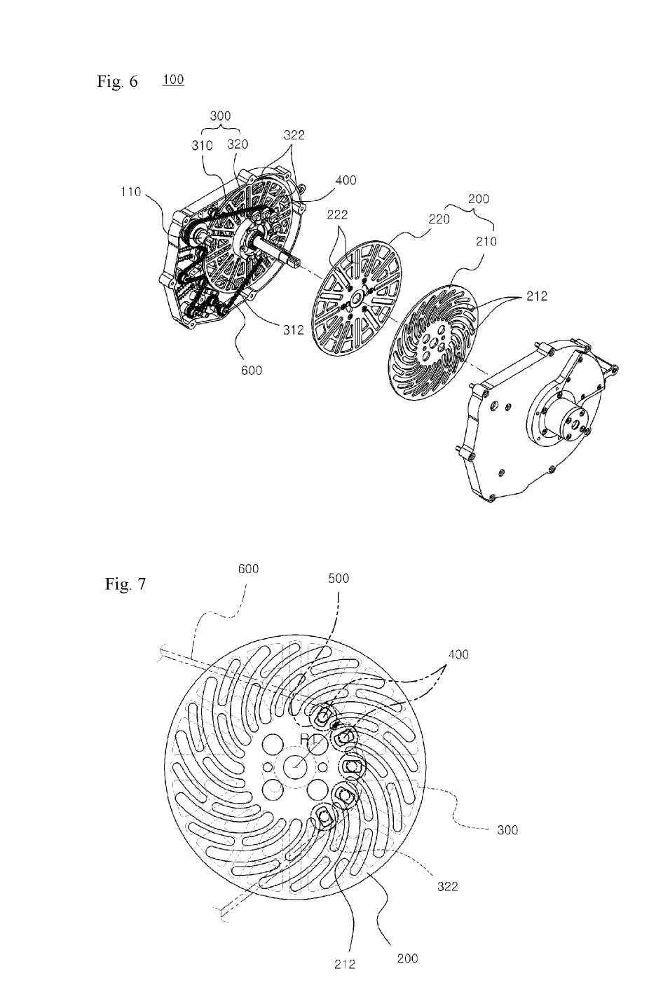

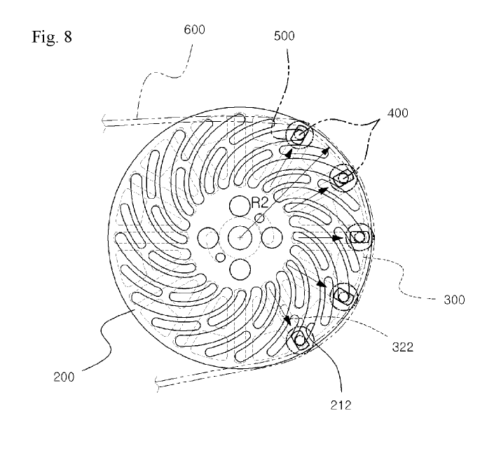

FIGS. 6 and 8 are diagrams for describing a continuously variable transmission adopting the one way clutch according to the present invention.

Referring to FIGS. 6 to 8, the continuously variable transmission 100 may include a first disk unit 200, a second disk unit 400, a guide member 400, and a one way clutch 500.

The first disk unit 200 and the second disk unit 300 are disposed to be spaced apart from each other at a predetermined interval and the guide member 400 is provided between the first disk unit 200 and the second disk unit 300 so as to move in a radial direction.

The first disk unit 200 may be constituted by only one disk member or a plurality of disk members according to the condition the design specification which are required. As one example, the first disk unit 200 may include a plurality of first disk members 210 and 220 and first guide slots 212 and 222 may be formed in the first disk members 210 and 220, respectively.

Hereinafter, an example in which the first guide slots 212 and 222 formed in the first disk members 210 and 220 are formed to cross each other will be described. As one example, the first guide slots 212 and 222 radially formed in any one first disk member 210 or 220 of two first disk members 210 and 220 may be formed in an involute curve form and the first guide slots 212 and 222 radially formed in the other first disk member 210 or 220 of two first disk members 210 and 220 may be formed in a straight form. Such a structure may prevent twisting and abnormal movement when the guide member 400 to be described below moves. Moreover, since the first guide slots 212 and 222 radially formed in any one of the first disk members 210 and 220 may be formed in the involute curve form, interference between the guide members 400 may be prevented during a shift operation.

The second disk unit 300 may be constituted by only one disk member or the plurality of disk members according to the condition the design specification which are required. As one example, the second disk unit 300 may include a plurality of second disk members 310 and 320 and second guide slots 312 and 322 crossing the first guide slots 212 and 222 may be formed in the second disk members 310 and 320, respectively. Hereinafter, an example in which the second guide slots 312 and 322 formed in the second disk members 310 and 320 are formed to cross each other will be described. As one example, the second guide slots 312 and 322 radially formed in any one second disk member 310 or 320 of two second disk members 310 and 320 may be formed in the involute curve form and the second guide slots 312 and 322 radially formed in the other second disk member 310 or 320 of two second disk members 310 and 320 may be formed in the straight form.

For reference, in the exemplary embodiment of the present invention, an example in which each of the first disk unit and the second disk unit is configured to include the plurality of disk members is described, but in some cases, any one of the first disk unit and the second disk may be constituted by the single disk member and the other one may be configured to include the plurality of disk members.

The guide member 400 is provided to define a rotary radius of a power transmission member 600.

Herein, defining the rotary radius of the power transmission member 600 by the guide member 400 may be appreciated as defining the rotary radius (a rotation trajectory radius) of the power transmission member 600 by a plurality of guide members 400 by commonly winding the power transmission member 600 on the circumferences of the plurality of guide members 400.

Further, the rotary radius of the power transmission member 600 wound on the circumference of the guide member 400 may vary in response to the movement of the guide member 400 in the radial directions of the first disk unit 200 and the second disk unit 300.

That is, one end of the guide member 400 may move along the first guide slots 212 and 222 while being accommodated in the first guide slots 212 and 222 and the other end of the guide member 400 may move along the second guide slots 312 and 322 while being accommodated in the second guide slots 312 and 322.

As the second disk unit 300 rotates with respect to the first disk unit 200 (alternatively, the first disk unit rotates with respect to the second disk unit), the guide member 400 moves along the first guide slots 212 and 222 and the second guide slots 312 and 322 to move in the radial directions of the first disk unit 200 and the second disk unit 300. Moreover, end finishing units 551 and 552 for guiding the movement of the guide member 400 may be coupled to both ends of the guide member 400 in order to prevent the power transmission member from being removed.

The one way clutch 500 may be provided to permit only the unidirectional rotation of the guide member 400 and as described above, the one way clutch 500 may include the inner race 510, the outer race 520, and the clutch element 530.

As the power transmission member 600, a general belt or chain may be used and the present invention is not restricted or limited by the type and the characteristic of the power transmission member 600. Hereinafter, as the power transmission member 600, the general chain may be used and an example in which a gear portion 524 which engages with the chain is formed on the outer peripheral surface of the outer race 520 will be described.

Referring to FIGS. 7 and 8, the guide member 400 moves in the radial direction of the first disk unit 200 (the second disk unit) in response to relative rotation of the second disk unit 300 to the first disk unit 200, and as a result, the rotary radius of the power transmission member 600 may selectively vary and driving force by simultaneous rotation of the first disk unit 200 and the second disk unit 300 is transferred to an output shaft 110 through the power transmission member 600 to be output.

Further, the one way clutch 500 allows the guide member 400 to rotate only in one direction during the shifting (when the guide member moves) to maintain continuity and stability of power transmission during the shifting.

Meanwhile, as a rotation means for relatively rotating the second disk unit 300 to the first disk unit 200, a general rotation means may be used in order for the guide member 400 to move in the radial direction of the first disk unit 200 (the second disk unit) and the present invention is not restricted or limited by the type and the characteristic of the rotation means.

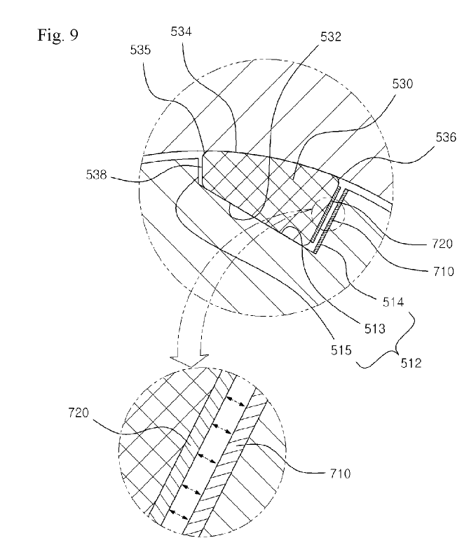

Meanwhile, FIG. 9 is a diagram for describing a dart game apparatus according to another exemplary embodiment of the present invention. Moreover, the same reference numerals or the same equivalent reference numerals denote the same and same equivalent parts as the aforementioned components and detailed description thereof will be omitted.

Referring to FIG. 9, the one way clutch according to another exemplary embodiment of the present invention may further include a return means 700 providing return force when the clutch element 530 in the locked state is returned in the unlocked state.

As the return means 700, various return means 700 capable of providing the return force for pushing the clutch element 530 adjacent to the first wall portion 514 to the second wall portion 515 may be used. As one example, the return means 700 may include a first magnet coating layer 710 formed on the surface of the first wall portion 514 and a second magnet coating layer 720 formed on the surface (the surface of the first end) of the clutch element 530 facing the first wall portion 514 so as to have repulsive force with the first magnet coating layer 710.

The first magnet coating layer 710 and the second magnet coating layer 720 may be made of a general magnetic material such as ferrite and the present invention is not restricted or limited by the material. Differently, as the return means 700, an elastic member such as a spring member may be used.

The present invention has been described with reference to the preferred embodiments of the present application. However, it will be appreciated by those skilled in the art that various modifications and changes of the present invention can be made without departing from the spirit and the scope of the present invention which are defined in the appended claims and their equivalents.

1. A one way clutch comprising:
an outer race;
an inner race disposed in the outer race to be coaxially rotatable; and
a wedge type clutch element provided between the outer race and the inner race,
wherein an element accommodation section is provided at least at any one side of an interface of the outer race and the inner race and the clutch element is accommodated in the element accommodation section,
wherein the clutch element includes a plane contact portion surface-contacting the element accommodation section and a curved clamping portion facing the plane contact portion, and
wherein the element accommodation section includes,
a plane floor portion formed to be inclined to a tangential direction of an outer peripheral surface of the inner race so that one end of both ends of the inner race is relatively closer to the center of the inner race, a first wall portion formed from one end of the plane floor portion relatively closer to the center of the inner race between both ends of the plane floor portion up to the outer peripheral surface of the inner race, and a second wall portion formed from the other end of the plane floor portion up to the outer peripheral surface of the inner race, and
the clutch element is disposed between the first wall portion and the second wall portion and the curved clamping portion is provided to surface-contact an inner peripheral surface of the outer race in a rotational direction of the outer race to the inner race to be selectively locked or unlocked on the inner peripheral surface of the outer race.

2. (canceled)

3. (canceled)

4. The one way clutch of claim 1, wherein while the clutch element is unlocked on the inner peripheral surface of the outer race, a gap ΔH of 0.001 mm to 0.05 mm is provided between the curved clamping portion and the inner peripheral surface of the outer race.

5. The one way clutch of claim 4, wherein an angle θ1 of the plane contact portion for a chord of the curved clamping portion is in the range of 5° to 20°.

6. The one way clutch of claim 5, wherein a movement distance ΔL of the clutch element to the plane floor portion is in the range of 0.003 mm to 0.572 mm at the time of switching the lock and the unlock with each other.

7. The one way clutch of claim 1, wherein an allowance tolerance L2 is provided between the second wall portion and the clutch element in the locked state of the clutch element.

8. The one way clutch of claim 1, wherein even element accommodation sections and clutch elements are provided in a circumferential direction of the inner race to be symmetric to each other base on the center of the inner race.

9. The one way clutch of claim 1, wherein a round processing unit is formed at a corner of the clutch element exposed to the outside of the element accommodation section.

10. The one way clutch of claim 1, further comprising:
a return means providing return force when the clutch element in the locked state is returned to the unlocked state.

11. The one way clutch of claim 10, wherein the return means includes
a first magnet coating layer formed on the surface of the first wall portion, and
a second magnet coating layer formed on the surface of the clutch element facing the first wall portion to have repulsive force with the first magnet coating layer.

12. A continuously variable transmission including a first disk unit with a first guide slot, a second disk unit with a second guide slot which the first guide slot crosses, and a guide member provided to move along the first guide slot and the second guide slot in response to relative rotation of the second disk unit to the first disk unit, the continuously variable transmission comprising:
a one way clutch integrally provided in the guide member,
wherein the one way clutch includes an inner race and an outer race defining at least one element accommodation section on an interface, and a wedge type clutch element is provided in the element accommodation section,
wherein the clutch element includes a plane contact portion surface-contacting the element accommodation section and a curved clamping portion facing the plane contact portion, and
wherein the element accommodation section includes,
a plane floor portion formed to be inclined to a tangential direction of an outer peripheral surface of the inner race so that one end of both ends of the inner race is relatively closer to the center of the inner race, a first wall portion formed from one end of the plane floor portion relatively closer to the center of the inner race between both ends of the plane floor portion up to the outer peripheral surface of the inner race, and a second wall portion formed from the other end of the plane floor portion up to the outer peripheral surface of the inner race, and
the clutch element is disposed between the first wall portion and the second wall portion and the curved clamping portion is provided to surface-contact an inner peripheral surface of the outer race in a rotational direction of the outer race to the inner race to be selectively locked or unlocked on the inner peripheral surface of the outer race.

13. (canceled)

14. (canceled)

15. The continuously variable transmission of claim 12, wherein while the clutch element is unlocked on the inner peripheral surface of the outer race, a gap ΔH of 0.001 mm to 0.05 mm is provided between the curved clamping portion and the inner peripheral surface of the outer race.

16. The continuously variable transmission of claim 15, wherein an angle θ1 of the plane contact portion for a chord of the curved clamping portion is in the range of 5° to 20°.

17. The continuously variable transmission of claim 16, wherein a movement distance ΔL of the clutch element to the plane floor portion is in the range of 0.003 mm to 0.572 mm at the time of switching the lock and the unlock with each other.

18. The continuously variable transmission of claim 12, wherein an allowance tolerance L2 is provided between the second wall portion and the clutch element in the locked state of the clutch element.

19. The continuously variable transmission of claim 12, further comprising:
a return means providing return force when the clutch element in the locked state is returned to the unlocked state.

20. The continuously variable transmission of claim 19, wherein the return means includes,
a first magnet coating layer formed on the surface of the first wall portion, and
a second magnet coating layer formed on the surface of the clutch element facing the first wall portion to have repulsive force with the first magnet coating layer.
